(19) United States
(12) Patent Application Publication
(10) Pub. No.: US 2005/0177713 A1
(43) Pub. Date: Aug. 11, 2005

(54) Multi-protocol network encryption system

(76) Inventor: Peter Sim, Surret Hills (AU)

Correspondence Address: FISH & RICHARDSON, PC, 12390 EL CAMINO REAL, SAN DIEGO, CA, 92130-2081, US

(21) Appl. No.: 10/773,763

(22) Filed: Feb. 5, 2004

(51) Int. Cl. H04L 9/00

(52) U.S. Cl. 713/151

(57) ABSTRACT

An encryption management system for a network. The system connects between a protected network and an unprotected network, and manages both encryption and decryption of a payload to be sent between the networks. The encryption and decryption uses different cryptography systems which are optimized for different kinds of encryption and decryption. For example, one system uses a hardwired encryptor while other systems may use a software encryptor. The signing keys are stored in a separate management unit which is connected to the main encryptor over a separate network interface and communicates with the main processor using simple network management protocol.

### BACKGROUND

Many different publicly available networks are known, such as the so-called SONET/SDH, ATM, Frame Relay networks. In many of these networks, the data on the network can represent anything. The data is divided into different chunks or frames, cells or packets. Each frame, cell or packet has its own set of overhead portions which may represent destination of the data and other information. The network handles the frames, cells or packets based on addressing contained in the envelope portions of the frame or packet.

In general, the network sends the data from a destination, via a switch, to a destination.

Security on these networks can be very important.

### SUMMARY

The present application describes an encryptor system which encrypts the payload of the SONET/SDH frame, ATM cell, Frame Relay frame or IP packet. The encryptor connects into the path between a local switch/router and the data network. The encryptor operates to encrypt different portions in different ways, and includes management functions for keys and remote operation. The overhead remains unencrypted so that the frame, cell or packet can be properly handled by the switch or switches along the path of the data.

### BRIEF DESCRIPTION OF THE DRAWINGS

These and other aspects will now be described in detail with reference to the accompanying drawings, wherein:

FIG. 1 shows a basic block diagram of the system and its connection; and

FIG. 2 shows a diagram of the internal architecture.

### DETAILED DESCRIPTION

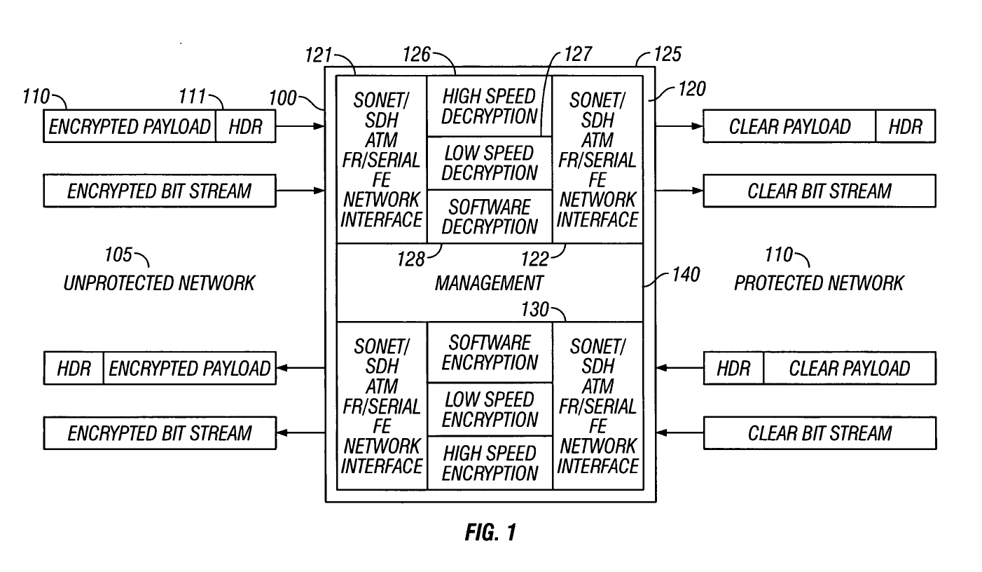

A basic block diagram of the system is shown in FIG. 1. The CypherNet 100 is connected between unprotected network 105 and protected network 110. An encrypted payload 110 is sent with an unencrypted overhead portion 111. The overhead portion 111 includes the addressing and other information, which is necessary for the network's use in routing the communication itself.

The system, as described herein, provides transparent encryption of SONET/SDH, ATM, Frame Relay and other similar connections. Individual data streams can either be encrypted or passed through without change, as defined in the connection table. According to the present system, the “payload” includes the parts of the data, such as packets of data, and/or frames of data.

According to the present system, a special encryptor unit for use with public networks is disclosed. This encryptor unit can be used to secure information over any number of similar format networks such as synchronous optical networks (SONET), synchronous digital hierarchy networks (SDH) networks, asynchronous transfer mode networks (ATM), frame relay networks (FR) and other similar networks. These networks can run at any of a number of different speeds. The device, referred to herein as CypherNet, connects as shown as 100 between the unprotected network 105 and the protected network 110.

According to aspects as disclosed herein, a special CypherManager may be used to securely and remotely manage the encryptors. A graphical user interface is used to set and monitor the CypherNet internal configuration parameters. The manager connects with the actual hardware unit using an existing network command protocol, here SNMPv3, commands over an ethernet network. This allows the manager to be treated as a subsystem, of one of the network portions, of the CypherNet.

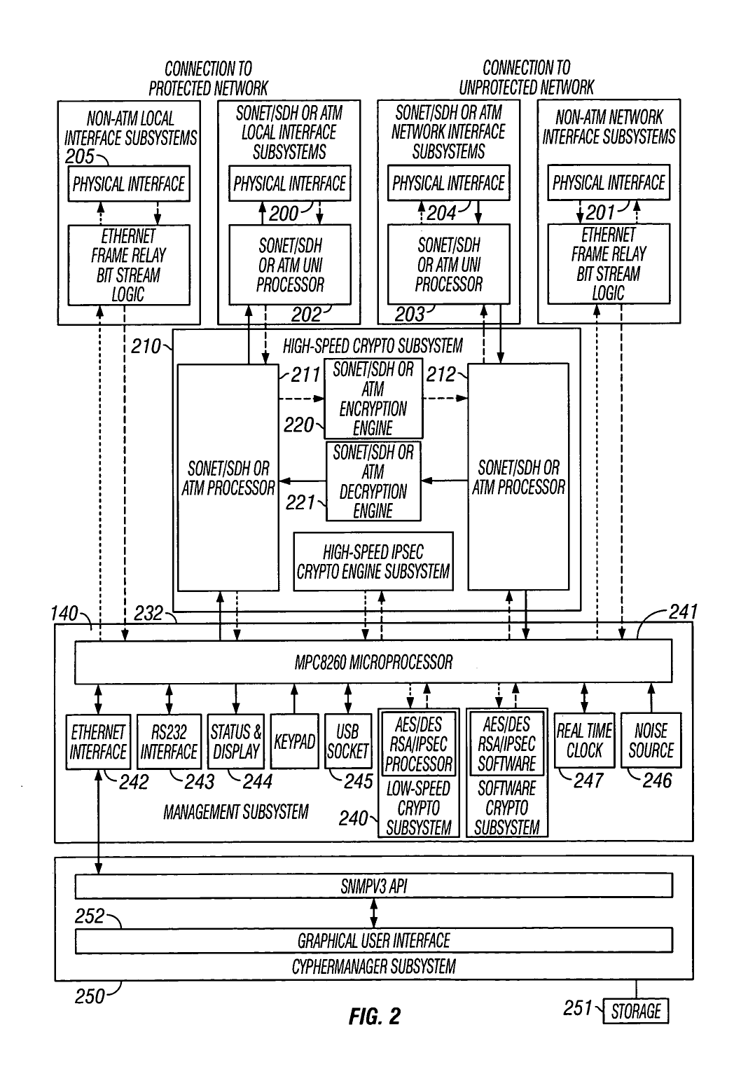

FIG. 2 of the CypherNet 100 includes decryption and encryption components. The decryption components 120 are used to decrypt information that is sent from the unprotected network 105 to the protected network 110. Conversely, the encryption portion encrypts information, which is sent from the protected network 105 to the unprotected, public network 105.

Each of the paths 120, 130 includes two network interfaces, surrounded by an encryption or decryption engine. The decryption path 120 includes a first network interface 121, a second network interface 122, and a decryption engine 125. The decryption engine, as described herein, includes three separate parts for the different kinds of information. A high-speed decryption portion may be used for the highest speed/most data intensive used portions of the encryption. A low-speed decryption 127 may be used for lower speed decryption, and a software decryption 128 may be used for other portions, which are less susceptible of decryption in this way.

Analogously, the encryption layer includes two network interfaces: high-speed encryption, low-speed encryption and software encryption portions.

FIG. 2 shows a further detailed architecture of the encryption, including the CypherManager subsystem 250 connected as one aspect of the unit. The CypherManager controls the operations of the processor and management subsystem 140 using conventional SNMPv3 communication.

As shown in FIG. 2, interfaces to a number of different subsystems are possible. A first interface may be to a SONET/SDH subsystem. For example, interface 200 may be a physical interface to a SONET SDH or ATM local interface subsystem. This is connected to a SONET/SDH/ATM processor, which operates to process the bits of the network message. The ATM processor receives the received ATM cells and processes the header. Typically the system discards the checksum byte, and the cell is then forwarded to the high-speed crypto system 210. The high-speed crypto system also includes a cell processor 211, which adds a crypto 32-bit crypto parameter field to the beginning of the cell. The crypto parameters are generated from the connection table for each define the VPI/VCI address. Those crypto parameters are then used by the encryption engine 220 and decryption engine 221 to select keys for the virtual circuit and to set the mode of the crypto engine.

After the crypto process is completed, the crypto parameters are removed and the header checksum byte is recalculated and reinserted within the cell header. The cell is then forwarded to the processor for the other interface subsystem, here shown as 212, and returned to the processor 203 and to the physical interface 204.

ATM interface subsystem is also formed by similar structure. The ATM processor processes the ATM cells and again discards the checksum byte. The cell is then forwarded to the processor 211, which again calculates a crypto parameter field based on the table for the addresses. Again, crypto parameters are removed after processing, and the header checksum byte is then recalculated and reinserted.

However, if the ATM virtual circuit has been configured for frame or IP based encryption, then the crypto parameters will have been set to indicate frame or IP encryption. The high-speed ATM crypto subsystems switches the cell to the ATM ports, for example port 232, on the processor system 140. This allows the processor to reassemble the frame or packet from the received cell system. After processing the complete frame or packet, the processor processes that frame, and determines its operation.

If configured for frame relay, then the frame is encrypted or decrypted by the low-speed crypto system 240, that is contained within the management system.

The operation also contemplates a serial interface subsystem. A serial received bit stream may be decrypted by the low-speed crypto system 240, or by a software crypto system contained within the management subsystem 140.

The management system 140 includes a processor 241, with a number of associated subportions for the processor. For example, the management system 140 may include an Ethernet interface for connections to other networks including the CypherManager subsystem. It may also include an RS-232 interface 243, as well as a user interface 244 which may include status and display as well as keep it. The USB port may be used for additional storage or upgrading the software/firmware. In addition, a noise source 246 and a real-time clock 247 are included as part of the subsystem.

An important part of the operation is carried out by the management, which is overseen by the CypherManager subsystem 250. This manager enables secure remote management. The CypherManager actually carries out the storage of certain keys and for this purpose includes a secure storage 251. In the embodiment, the CypherManager stores a CA private key that is used to sign X.509 certificates that allow verification of the identity of the CypherNET encryptors. All keys used to encrypt data between the encryptors are generated internally to each encryptor and exchanged initially between the encryptors using RSA public key encryption, and then using the X.509 certificates for authentication.

When the power is removed from the encryptor or it is tampered with, all these keys are destroyed. The encryptors private key is typically maintained through power cycles but is destroyed if the unit is tampered with.

The storage includes a database with two internal tables. A first table is used to store the X.509 private key. The private key is encrypted using an encryption schemes such as AES, using a 256 bit key generated from a password. The database also stores the IP address of CypherNet encrypters that have been discovered for each CypherManager user. In this way, the database can be used to retrieve the list of the discovered encrypters when the user logs in, and also to retrieve the encrypted private key to sign certificates such as X.509 certificates. The certificates can not be signed, however, unless the user enters the proper password to sign the certificate.

The CypherManager uses a number of interconnecting software modules to allow user login, password entry, signing and validation, as well as creation and maintenance of various tables and operations. A user logs in using the graphical user interface, and enters an appropriate password that matches a password stored in the CypherNet unit. This enables the user to access the various functions, and by doing this, to manage the various operations.

The present system provides use of multiple different crypto subsystems in order to process different kinds of information. The four basic crypto subsystems include the software crypto system, the low-speed crypto system, the high-speed SONET/SDH system and the high-speed ATM system. An advantage of dividing the elements in this way is that better efficiency can be obtained by using different system capabilities to encrypt and decrypt different kinds of information. For example, in an embodiment, the high-speed crypto systems are dedicated hardware modules, which are dedicated to encryption and/or decryption of a specified format and type of message. For example, the encryption engine 220 may be a SONET/SDH encryption engine formed in hardware. This may be a card that plugs into a backplane within the high-speed crypto system 210. The hardware unit is optimized for the specific function, here encrypting SONET/SDH, and may produce very high throughput for that particular operation. However, the engine can only carry out the processing of its one appointed task. A number of cards can be added to increase or decrease the capability of the system in this way. However, the high-speed crypto system includes very highly specialized equipment. Also faster cards or additional cards can be added to the system to increase the processing capability.

The low-speed crypto system such as 240 may be less specialized, it still includes its own dedicated processor for carrying out the decryption. In this way, the low-speed crypto processor may carry out a number of functions besides simply encryption or decryption of the stream. For example, this may use RSA for processing in its own dedicated processor.

All other functions can be carried out by the software crypto system. While any encryption or decryption whatsoever can be done in software, by simply writing the program, this may be the slowest of the different systems.

The software crypto subsystem is used to process ATM cells, FR frames, IPSec packets and bit streams in the low speed products. It also provides key generation, RSA, Diffie-Hellman, MD5 and SHA-1 services.

The low-speed crypto subsystem uses two security processors to process the ATM cells, FR frames, IPSec packets and bit streams and is used in the medium speed products. The low-speed crypto subsystem replaces the crypto functions in the software crypto subsystem with processor devices. It also provides RSA, Diffie-Hellman, MD5 and SHA-1 services.

The high-speed SONET/SDH crypto module is used to process SONET/SDH frames. The high-speed SONET/SDH crypto subsystem is available in a 2.4 Gbps version and a 10 Gbps version. There is no difference in the processing of the SONET/SDH frames between the two versions and hence they are treated as one subsystem for simplicity.

The high-speed ATM crypto module is used to process ATM cells. The high-speed ATM crypto subsystem can use a 155 Mbps card or a 622 Mbps card. There is no difference in the processing of the cells between the two versions and hence they are treated as one subsystem for simplicity.

The high-speed IPSec crypto subsystem is used to process IP packets.

Cells, frames, packets or bit streams received on the local port from the protected network are processed and passed through the encryption subsystem and then forwarded to the unprotected network.

Cells, frames, packets or bit streams received on the network port from the unprotected network are processed and passed through the decryption subsystem and then forwarded to the protected network. Further detail about the subsystems follows.

The software crypto subsystem provides all the cryptographic functions, including key generation and key management, required by CypherNET in software.

There are no speed hardware components in the software crypto subsystem. However, the hardware noise source 246 on the management subsystem provides a random seed for the key generation process.

The software crypto subsystem uses the following software modules.

1. AES encryption/decryption

2. DES encryption/decryption

3. MD5 hash generation

4. SHA-1 hash generation

5. RSA encryption/decryption service

6. Authentication of signed X.509 certificates

7. Secure storage of the RSA private key and user passwords

8. Generation of cryptographic keys

9. Creation of RSA public and private keys

10. RSA encryption/decryption service

11. Creation of Diffie-Hellman keys.

The low-speed crypto subsystem connects to the management subsystem. The subsystem provides low speed AES/DES encryption/decryption, assists in RSA encryption/decryption and MD5/SHA-1 hash calculations and performs the IPSec transformations and encryption and decryption functions.

The low-speed crypto subsystem uses two AES/DES/RSA/MD5/SHA-1/IPSec Security Processors.

The low-speed crypto subsystem can connect to the Management subsystem to provide communication between the management subsystem microprocessor and the two security processors. The interface is used to
Initialize the security processors, and
Transfer data to and from the security processors. It is also used to test the correct operation of the security processors
When diagnostic tests are run the microprocessor loads known keys into the AES/DES/RSA/IPSec/MD5/SHA-1 algorithms and then a test message is loaded. The message is processed, read back by the microprocessor and compared with the expected result. If an error is detected, an audit entry is generated.

The high-speed SONET/SDH crypto subsystem connects to the management subsystem and the local and network subsystems.

It encrypts the payload of the SONET/SDH frames received on the local port and decrypts SONET/SDH frames received on the network interface. The encrypted frame is forwarded to the network interface subsystem for transmission to the unprotected network. The decrypted frame is forwarded to the local interface subsystem for transmission to the protected network. Section, line and path overhead bytes bytes are passed through the encryption subsystem encrypted, unmodified or zeroised. The encryptor can be configured as a line encryptor or path encryptor. When configured as a line encryptor, the complete payload is encrypted, including the path overhead bytes. When configured as a path encryptor each path is encrypted using different keys and the path overhead bytes are not encrypted.

The high-speed SONET/SDH crypto subsystem uses the following hardware components:

1. Encrypt/Decrypt SONET/SDH FPGA

2. SDRAM for storing the connection table

3. Control CPLD

4. Flash memory for holding the FPGA definitions

The Encrypt/Decrypt FPGA is used to determine whether the received payload on the network interface is decrypted, passed through unchanged or is zero'ed. This is achieved by checking whether the connection table has an entry. If there is a connection table entry, then the frame is forwarded to the decrypt engine. If there is no entry, then the payload of the frame is zero'ed.

When the decrypt engine receives the frame it determines the action to take from information contained in the connection table. If the payload is to be decrypted, information contained in the connection table is used to load the keys etc. for that particular connection into the AES engine. The payload of the frame is then decrypted. The frame with the decrypted, unchanged or zero'ed payload is then forwarded to the local interface subsystem.

The Encrypt/Decrypt FPGA is used to determine whether the received payload on the local interface is encrypted, passed through unchanged or is zero'ed. This is achieved by checking whether the connection table has an entry. If there is a connection table entry then the frame is forwarded to the encrypt engine. If there is no entry, then the payload of the frame is zeroised.

When the encrypt engine receives the frame, it determines the action to take from information contained in the connection table. If the payload is to be decrypted, information contained in the connection table is used to load the keys for that particular connection into the AES engine. The payload of the frame is then encrypted. The frame with the encrypted, unchanged and zero'ed payload is then forwarded to the network interface subsystem.

The connection tables are generated from the CAT table, which is obtained from the processor subsystem.

The management subsystem microprocessor generates the master key and initial session key for each entry in the connection table. After an entry has been added to the connection tables, the microprocessor encrypts the master and initial session keys using the RSA service and inserts them into the outgoing management channel on the network interface. The key exchange mechanism is defined in the ATM Forum Security Specification V1.1. The initial session key is also stored in the encrypting SDRAM.

The network interface also receives the encrypted master/initial session keys from the far end encryptor and uses the RSA service to decrypt the keys. The initial session key is stored in the decrypting SDRAM. The master key is used to decrypt the incoming periodic session key updates received from the far end encryptor. The incoming periodic session keys update the key material contained in the decrypt SDRAM.

The high-speed ATM crypto subsystem connects to the management subsystem and the local and network subsystems and works analogously to the high speed SONET system to encrypt the payload of the ATM cells received on the local port and decrypts cells received on the network interface. The encrypted cell is forwarded to the network interface subsystem for transmission to the unprotected network. The decrypted cell is forwarded to the local interface subsystem for transmission to the protected network. Network management OAM cells, other than OAM cells associated with key updates, are always passed through the encryption subsystem unmodified.

The high-speed ATM crypto subsystem may use:

5. Ingress Cell Processor

6. Egress Cell Processor

7. SDRAM for storing the ingress connection table

8. SDRAM for storing the egress connection table

9. Ingress CAM

10. Egress CAM

11. Encrypt Engine FPGA

12. Decrypt Engine FPGA

13. SDRAM for storing encrypt keys and IV's for each active connection

14. SDRAM for storing decrypt keys and IV's for each active connection

15. Control CPLD

16. SDRAM for holding FPGA definitions

17. High-speed IPSec Processor

The Ingress Cell Processor is used to determine whether the received cell on the network interface is decrypted, passed through unchanged, discarded or is carrying a higher layer protocol. This is achieved by extracting the VPI/VCI address from the ATM cell header and then checking whether the connection table for that address has an entry. If there is a connection table entry then the cell is forwarded to the decrypt engine with an extended header that contains information on how the cell is to be processed. If there is no entry, then the cell is discarded.

When the decrypt engine receives the cell, it determines the action to take from information contained in the extended header. If the cell is to be decrypted, address information contained in the extended header is used to load the keys and IV's for that particular virtual circuit into the AES or DES engine. The payload of the cell is then decrypted and the IV saved in the decrypt SDRAM. The cell with the decrypted or unchanged payload is then forwarded to the egress cell processor, which forwards the cell after removing the extended header to the network interface subsystem.

The Egress Cell Processor is used to determine whether the received cell on the local interface is encrypted, passed through unchanged, discarded or is carrying a higher layer protocol. This is achieved by extracting the VPI/VCI address from the ATM cell header and then checking whether the connection table for that address has an entry. If there is a connection table entry then the cell is forwarded to the encrypt engine with an extended header that contains information on how the cell is to be processed. If there is no entry, then the cell is discarded.

When the encrypt engine receives the cell it determines the action to take from information contained in the extended header. If the cell is to be encrypted address information contained in the extended header is used to load the keys and IV's for that particular virtual circuit into the AES or DES engine. The payload of the cell is then encrypted and the IV saved in the decrypt SDRAM. The cell with the encrypted or unchanged payload is then forwarded to the ingress cell processor, which forwards the cell after removing the extended header to the local interface subsystem.

The connection tables are generated from the CAT table, which is obtained from the processor subsystem. For large numbers of connection table entries a Content Addressable Memory (CAM) device is used to speedup the connection lookup. The VPI/VCI address is presented to the CAM, which responds with a pointer to the relevant entry in the connection table.

The management subsystem microprocessor generates the master key and initial session key for each entry in the connection table. After an entry has been added to the connection tables, the microprocessor encrypts the master and initial session keys using the RSA service and inserts them into the outgoing cell stream on the network interface. The key exchange mechanism is defined in the ATM Forum Security Specification V1.1. The initial session key is also stored in the encrypt SDRAM.

The network interface also receives the encrypted master/initial session keys from the far end encryptor and uses the RSA service to decrypt the keys. The initial session key is stored in the decrypt SDRAM. The master key is used to decrypt the incoming periodic session key updates received from the far end encryptor. The incoming periodic session keys update the key material contained in the decrypt SDRAM.

Analogously, the local interface subsystem receives cells 202, 206 directly from the unprotected network, and forwards them directly to the processor system. The processor 241 may either handle these cells directly, or assign to the low-speed crypto system.

Another aspect of this system its tamper resistance. An automatic memory erasure can be carried out when system interlocks are activated.

Although only a few embodiments have been described in detail above, other modifications are possible. For example, while the above has referred to only a few network protocols and formats, of course, other protocols and formats are contemplated.

1. A network encryption system, comprising:
a first network interface, adapted for connection to a protected network;
a second network interface, adapted for connection to an unprotected network;
a processing part, which manages the encryption of information payload to be sent to the unprotected network, and decryption of information payload which are received from the unprotected network, and said processing part includes a microprocessor therein; and
an encryption and decryption system, including a first high-speed crypto system which operates using dedicated hardware components for cryptographic encryption and decryption, and a second, lower speed crypto system, which carries out said cryptographic operations without dedicated hardware components.

2. A system as in claim 1, wherein said first high-speed crypto system uses field programmable gate arrays which are configured to carry out a specific encryption or decryption operation.

3. A system as in claim 1, wherein said first low-speed crypto system includes a first portion using a cryptographic processor, and a second crypto portion using software running on a general-purpose processor.

4. A system as in claim 1, further comprising a key management subsystem, connected to said processing part via a network interface and communicating using a network management protocol, said key management subsystem storing encrypted software keys therein.

5. A system as in claim 4, wherein said key management subsystem and said processing part communicate via Simple Network Management Protocol.

6. A system as in claim 4, wherein said key management subsystem stores at least one private key by encrypting said keys using a password for the encryption.

7. A system as in claim 4, wherein said key management system maintains addresses of other key management systems.

8. A system as in claim 1, wherein said first high-speed crypto system includes at least one card.

9. A system as in claim 8, wherein said high-speed crypto system includes a first card optimized for encryption of SONET frames and a second card optimized for encryption of ATM cells.

10. A system as in claim 4, further comprising a security interlock on said key management subsystem, and a memory erase function which erases said memory when said security interlock is violated.

11. A system as in claim 1, wherein said encryption and decryption system includes a portion which removes a header associated with the network interface, replaces said header with a cryptographic header, processes said message using the cryptographic header, and then generates a new header associated with the network interface.

12. A system, comprising:
a first network interface, adapted for connection to a protected network;
a second network interface, adapted for connection to an unprotected network;
a processing part including a third network interface, said processing part managing encryption of data from said unprotected network and sending said data to said protected network, and managing decryption of data from said protected network and sending said data to said unprotected network in a specified form; and
a key management subsystem, storing encrypted keys therein for use in decryption by said processing part, connected to said processing part by a network protocol and connected to said third network interface.

13. A system as in claim 12, wherein said network protocol of said third network interface is SNMPV3.

14. A system as in claim 12, wherein said unprotected network is a SONET network.

15. A system as in claim 12, wherein said unprotected network is an ATM network.

16. A system as in claim 12, wherein said unprotected network is a Frame Relay network.

17. A system as in claim 12, wherein said unprotected network is a IP network,

18. A system as in claim 12, wherein said processing part includes an encryption and decryption system, including a high-speed crypto system formed of hardware encryption parts, and a lower speed crypto system operating using a crypto processor.

19. A system as in claim 18, wherein said lower speed crypto system includes a first part that operates in software, and a second part that operates using a cryptographic processor.

20. A system as in claim 18, wherein said high-speed crypto system is formed of field programmable gate arrays.

21. A system as in claim 18, wherein said encryption and decryption system operates to remove a header associated with a network protocol of said unprotected network, and a header associated with cryptographic functions, process a message portion using said header associated with cryptographic functions, and then read generate a header associated with the network protocol.

22. A method, comprising:
connecting to a first network which is a protected network and a second network which is an unprotected network;
encrypting data being sent from said first network to said second network, and decrypting data being sent from said second network to said first network; and
storing and managing at least one signing key in a separate unit from the unit carrying out the encrypting, and communicating with said separate unit, over a separate network from said first and second network.

23. A method as in claim 22, wherein said encrypting comprises removing a header associated with a network protocol of said second network;
obtaining key information from said separate unit, and forming an encryption header based on said key information and associating said encryption header with a message fragment;
encrypting the message fragment, using said encryption header; and
regenerating the header associated with the network protocol.

24. A system as in claim 1, wherein at least one of said network interfaces is an Ethernet network.
